(19) United States
(12) Patent Application Publication
(10) Pub. No.: US 2025/0260570 A1
(43) Pub. Date: Aug. 14, 2025

(54) SYSTEM AND METHOD FOR SECURING CRYPTOGRAPHIC KEY MATERIAL

(71) Applicant: Jason E. Thomas, Temecula, CA (US)

(72) Inventor: Jason E. Thomas, Temecula, CA (US)

(21) Appl. No.: 18/819,165

(22) Filed: Aug. 29, 2024

Related U.S. Application Data
(60) Provisional application No. 63/552,987, filed on Feb. 13, 2024.

(51) Int. Cl. H04L 9/08

(52) U.S. Cl. CPC H04L 9/0894; H04L 9/0869

(57) ABSTRACT

A method for operating secure computer processes includes storing a local encryption key in a register of a processor. The local encryption key is stored in a masked state. The method further includes receiving, from a memory communicating with the processor, an operational encryption key. The method includes encrypting the operational encryption key using the local encryption key and an initialization vector to generate an encrypted operation key. The local encryption key is unmasked prior to encrypting the operational encryption key. Further, the method includes storing the encrypted operational key, the initialization vector, and a verification hash value in the memory. The method includes decryption of symmetric operational keys directly to processor registers without using memory. The method includes decryption of asymmetric operational keys. In the method, the asymmetric key material is decrypted temporarily to memory and that memory is sanitized following the use of the key.

### CROSS-REFERENCE TO RELATED APPLICATIONS

This application claims the benefit of priority of U.S. provisional application No. 63/552,987, filed Feb. 13, 2024, titled “SYSTEM AND METHOD FOR SECURING CRYPTOGRAPHIC KEY MATERIAL,” the entire contents of which are herein incorporated by reference.

### FIELD

The present disclosure relates to cryptography, and more particularly, to securing cryptographic keys and materials from a large range of attack vectors.

### BACKGROUND

Current computing systems and methods utilize cryptography as a security measure. However, current systems and methods are tailored to specific attack vectors and do not allow for broad protection against threats. Specifically, current systems and methods are vulnerable to memory safety issues and side-channel attacks that exploit caches and memory.

As can be seen, there is a need for cryptographic security systems and methods that can protect against a broad range of attack vectors.

### SUMMARY

In one aspect of the present disclosure, a method for operating secure computer processes includes storing a local encryption key in a register of a processor. The local encryption key is stored in a masked state. The method further includes receiving, from a memory communicating with the processor, an operational encryption key. The method includes encrypting the operational encryption key using the local encryption key and an initialization vector to generate an encrypted operation key. The local encryption key is unmasked prior to encrypting the operational encryption key. Further, the method includes storing the encrypted operational key, the initialization vector, and a verification hash value in the memory. Additionally, the method includes removing the operational encryption key from the memory.

In aspects, the method includes decryption of symmetric operational keys directly to processor registers without using memory. The method also includes using the operational symmetric keys from within the registers directly to perform encryption/decryption on data-preventing the plaintext operational key from being in memory. Thus, the symmetric keys are never put in memory in plaintext following the initial encryption with the local encryption key. In aspects, the method includes decryption of asymmetric key. In the method, the asymmetric key material is decrypted temporarily to memory and that memory is sanitized following the use of the key-limiting the time that the plaintext key is in memory.

### BRIEF DESCRIPTION OF THE DRAWINGS

FIG. 1 is a block diagram of a secure key cryptographic library, according to aspects of the present disclosure;

FIG. 2 is a flow diagram of an initialization/utilization of a secure key cryptographic library, according to aspects of the present disclosure;

FIG. 3 is a flow diagram of key management functions including key initialization, according to aspects of the present disclosure;

FIG. 4 is a flow diagram of key management functions including symmetric key encryption, according to aspects of the present disclosure;

FIG. 5 is a flow diagram of key management functions including symmetric key decryption, according to aspects of the present disclosure;

FIG. 6 is a flow diagram of key management functions including asymmetric key encryption, according to aspects of the present disclosure;

FIG. 7 is a flow diagram of key management functions including asymmetric key decryption, according to aspects of the present disclosure;

FIG. 8 is a flow diagram of shielding an instruction set of a processor, according to aspects of the present disclosure; and

FIG. 9 is a flow diagram of vector packet processing, according to aspects of the present disclosure.

### DETAILED DESCRIPTION OF THE DISCLOSURE

The following detailed description is of the best currently contemplated modes of carrying out exemplary embodiments of the disclosure. The description is not to be taken in a limiting sense but is made merely for the purpose of illustrating the general principles of the disclosure, since the scope of the disclosure is best defined by the appended claims.

As stated above, current systems and methods for cryptographic prevention of attacks on computing systems are specifically tailored to address known attack vectors. Even more, because current systems store cryptographic keys in memory, they are vulnerable to memory safety issues and side-channel attacks.

Broadly, an embodiment of the present disclosure provides a system and methods for providing broad-based protection using a secure key library functionality, according to aspects of the current disclosure. The secure key library has been designed with security at the core. To that end, the secure key library incorporates numerous novel security features that have not previously been incorporated into other commercially available cryptographic libraries. The goal is to not just protect against a few specific attack vectors, but to protect against a broad range of attacks that are exploitable on other libraries. The secure key library enables securing key material and private data to a higher level than any other offering on the market while achieving similar performance.

The base architecture of the library protects key material by encrypting and authenticating keys using an Advanced Encryption Standard (AES) with Galois Counter Mode (GCM), for example, AES-256-GCM with a root key called the Local Unique Key (LUK). The library uses isolated cryptographic threads to process requests and only these threads possess (access) the LUK and are capable of decrypting protected keys. The LUK is held securely inside processor registers, and it is not stored in memory or caches after it has been initialized. The crypto threads perform a limited set of functions and all input to the threads is regulated by library function calls. In this way, the most sensitive security parameters are protected and isolated from the application that uses the secure key library.

In embodiments, the systems and methods include the decryption of symmetric operational keys directly to processor registers without using memory. The systems and methods include using the operational symmetric keys from within the registers directly to perform encryption/decryption on data-preventing the plaintext operational key from being in memory. As such, the symmetric keys are never put in memory in plaintext following the initial encryption with the local encryption key. In embodiments, the systems and methods include decryption of asymmetric key. In the systems and methods, the asymmetric key material is decrypted temporarily to memory and that memory is sanitized following the use of the key-limiting the time that the plaintext key is in memory.

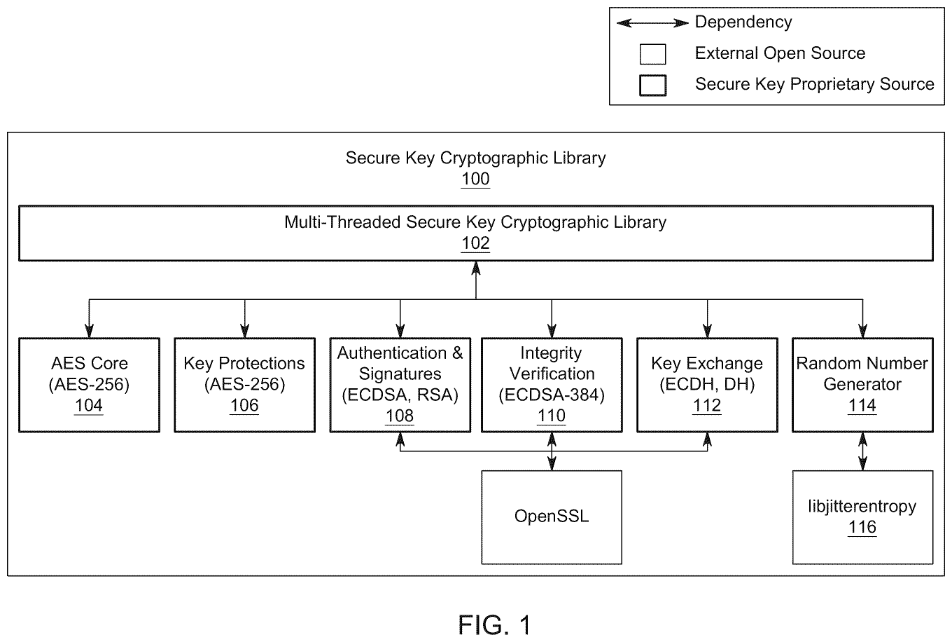

Referring now to FIGS. 1-9, FIG. 1 illustrates a block diagram of an embodiment of a Secure Key Cryptographic Library (SKCL) 100. While FIG. 1 illustrates examples of components of SKCL 100, additional components can be added and existing components can be removed and/or modified.

The SKCL 100 can include several functional modules that perform the cryptographic process described herein. The modules can include software, hardware and/or a combination of both to perform the described functionality. The SKCL 100 includes a Multi-Thread Secure Key Cryptographic Library (MTSKCL) 102. The MTSKCL 102 can include the functionality to isolate cryptographic threads to process requests and only these threads possess a Local Unique key (LUK) and can be capable of decrypting protected keys. The crypto threads of the MTSKCL 102 can perform a limited set of functions and all input to these threads can be regulated by library function calls. Advantageously, the most sensitive security parameters can be protected and isolated from the application that uses the SKCL 100.

The SKCL 100 also includes an AES Core module 104, a Key Protections Module (KPM) 106, an Authentication and Signatures Module (ASM) 108, an Integrity Verification Module (IVM) 110, a Key Exchange Module (KEM) 112, and a Random Number Generator Module (RNGM) 114. The AES Core module 104 can provide the functionality to perform encryption and decryption. In embodiments, the AES Core module 104 can perform AES-256 GCM encryption/decryption for the crypto threads. The KPM 106 can provide the functionality to encrypt/decrypt key material using the LUK, for example, AES-256 encryption/decryption key materials and processes. The ASM 108 can provide the functionality to perform Elliptic Curve, for example, an Elliptic Curve Digital Signature Algorithm (ECDSA), and Public-key, for example, Rivest-Shamir-Adleman (RSA), cryptography using library function calls, for example, Open Secure Socket Layer (OpenSSL). The decryption key, i.e., private key, for the public-key system can be protected utilizing the KPM 106, providing an extra-layer of security.

The IVM 110 can provide the functionality to perform Known Answer Tests (KATs) for algorithms and memory integrity validations. The KATs can measure and verify the signature of executable memory in RAM, which advantageously protects processed keys from hardware and software failures, including: memory corruption attack, return-oriented programming attacks and Jump-oriented programming attacks. The KEM 112 can provide the functionality to perform key generation utilizing variations of Diffie-Hellman, for example, Elliptic Curve Diffie-Hellman and/or Diffie-Hellman key exchange, utilizing library function calls, for example, OpenSSL. In an embodiment, once the KEM 112 performs key exchange, private keys are protected using the KPM 106.

The RNGM 114 can provide the functionality of generating non-deterministic random bits utilizing hardware and software components. For example, known functions that utilize variations in processing such as jitter, or noise, as well as Physically Unclonable Functions (PUFs) can be used to generate non-deterministic random bits. In an embodiment, the jitterentropy library 116 can be used by the RNGM 114 to generate non-deterministic random bits. In some embodiments, the jitterentropy library 116 used for random number generation can be compliant with National Institute of Standards and Technology (NIST) Special Publication 800-90A, SP 800-90B, and SP 800-90C.

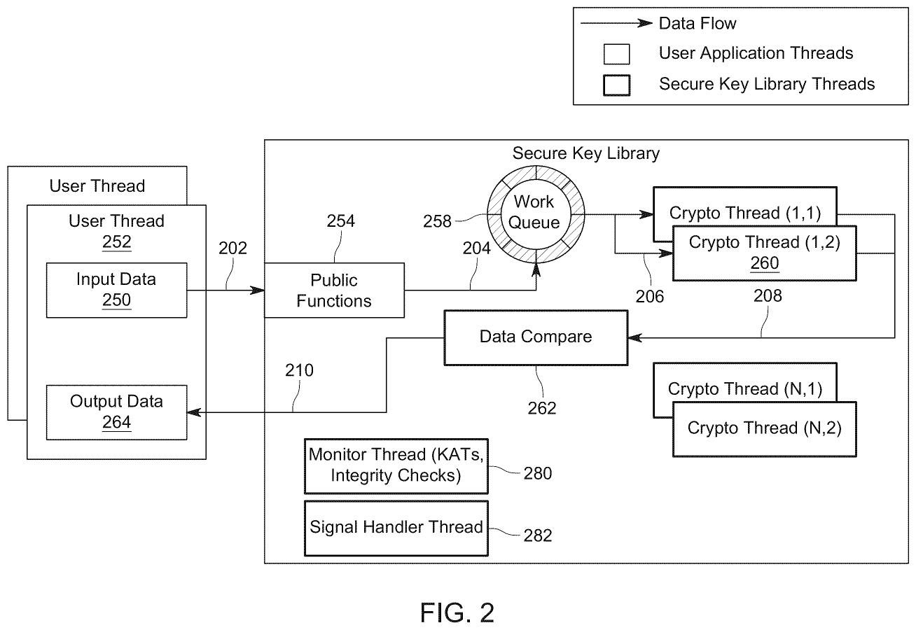

FIG. 2 illustrates a flow diagram for initialization/utilization of the SKCL 100. While FIG. 2 illustrates examples of components and data processes of the SKCL 100, additional components can be added and existing components and data processes can be removed and/or modified.

The SKCL 100 can be initialized when linked by an application process. Specifically, at data flow 202, input data 250 from a user thread 252 can be sent to the SKCL 100. A public functions process 254 can act to segregate the input data 250 from the rest (other modules and processes) of the SKCL 100, thereby minimizing a potential attack surface. At data flow 204, the public functions process 254 can provide the input data 250 to a work queue 258, which can provide the input data 250 to one or more cryptographic threads 260 at data flow 206.

In embodiments, upon first use of cryptographic operations by the process, multiple threads 260 can be created. Runtime environment variables control the number of threads created for cryptographic processing while, for example, two threads are always created for library monitoring 280 and signal handling 282. The SKCL 100 can be configured for secure redundancy, and in this case a crypto thread (1, 1) can be paired with another duplicate crypto thread (1, 2) that can run identical cryptographic operations, at data flow 206. The redundant threads can share a common thread used for data verification processes 262, which occurs at data flow 208. If the SKCL 100 is not configured for secure redundancy the data flow 208 can be omitted and the crypto thread 260 will copy the output data directly to the requested output buffer at data flow 210. The number of threads used by the SKCL 100 can be controlled by a user and the process that launches the application by setting environment variables. Some instances may require just a single thread, while other applications like high speed data-plane encryption can optimize the number of threads based on the available resources and other processes running on the system. In embodiments, the SKCL 100 allows for a configurable number of crypto threads based on the use-case.

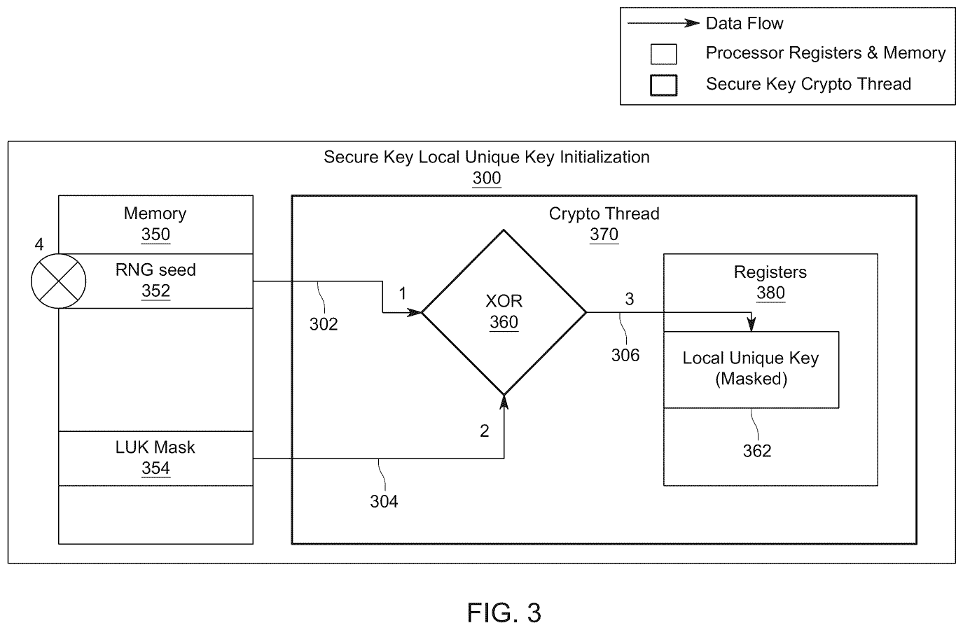

FIG. 3 illustrates a flow diagram of an embodiment of key protection for keys utilized for encryption, according to aspects of the disclosure. While FIG. 3 illustrates examples of components and data processes of the SKCL 100, additional components can be added and existing components and data processes can be removed and/or modified.

The initialization of the Local Unique Key (LUK) can be performed by every thread used for cryptographic processing, for example, the crypto threads as described in FIG. 2. The LUK can be a root key used to directly encrypt or derive child keys and/or used to encrypt other keys secured by the SKCL 100. Erasure of the LUK from cryptographic thread registers is sufficient for zeroization of the SKCL 100.

In embodiments, the LUK initialization data flow 300 can begin when a random number seed 352 can be generated and sent to a logic operation 360, at data flow 302. The random number seed can be stored in a memory 350. At data flow 304, a LUK mask 354 can be generated and sent to the logic operation 360. In an embodiment, the random number seed 354 and the LUK mask 354 can be generated using non-deterministic random number generators, can be a 256-bits in length, and the logic operation 360 can be an exclusive-or (XOR). At data flow 306, the seed 352 and the LUK mask 354 are mixed utilizing the logical operation 360 to generate a Masked LUK 362, which can be stored in local non-memory registers 380. For example, the registers 380 can be registers of one or more processors. After initialization of all threads, the seed 352 is zeroed out to prevent an attack surface for discovering the Masked LUK 362. The LUK mask 354 can be saved in private memory, for example, a private area of memory 350, so as to be able to recreate the Masked LUK 362, when required.

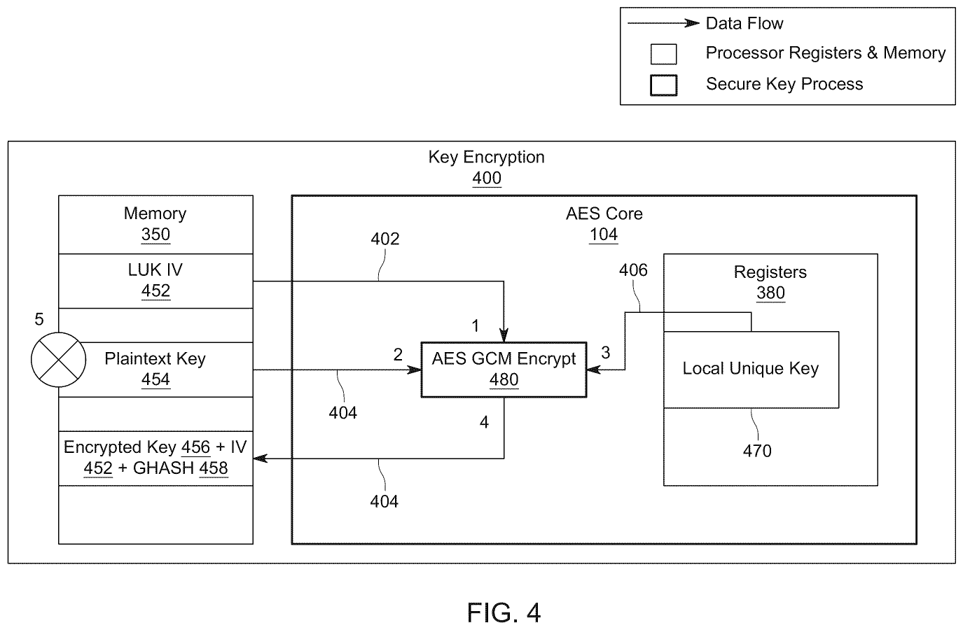

FIG. 4 illustrates a flow diagram of an embodiment to encrypt a symmetric key, according to aspects of the disclosure. While FIG. 4 illustrates examples of components and data processes of the SKCL 100, additional components can be added and existing components and data processes can be removed and/or modified.

The key encryption process 400 begins at step 402 where a LUK Initialization Vector (LUK IV) 452, or counter, can be incremented and can be loaded from a memory, e.g., the memory 350, into AES Core 104. At step 404, a plaintext key 454 can also be loaded into AES Core 104.

At step 406, a LUK 470 can be reconstituted and can be used to encrypt the plaintext key 454 at AES Core 104. For example, the masked LUK 362, stored in the registers 380, can be unmasked to access the LUK 470. The plaintext key 454 can be encrypted using an AES GCM algorithm 480. As such, the LUK 470 is not in plaintext until it is needed for encryption, e.g., it is masked using some piece from memory and some piece from registers (split). In some embodiments, the LUK 470 can be masked using XOR with random data. In some embodiments, the LUK 470 can be masked using different masking techniques (e.g., hash-based masking).

At step 408, the encrypted ciphertext key 456, a GHASH 458 and LUK IV 452 can be stored to a memory, e.g., the memory 350, and the plaintext key 454 can be zeroed to prevent an attack surface. GHASH 458 is the mechanism AES-GCM uses for integrity verification. The GHASH is written to a memory, e.g., the memory 350, as part of AES-GCM encryption (it is 128-bits) and is used by the SKCL 100 to verify the key when it is later decrypted. The GHASH 458 is used as an integrity check to make sure the memory 350 contents of the encrypted key 456 have not been modified.

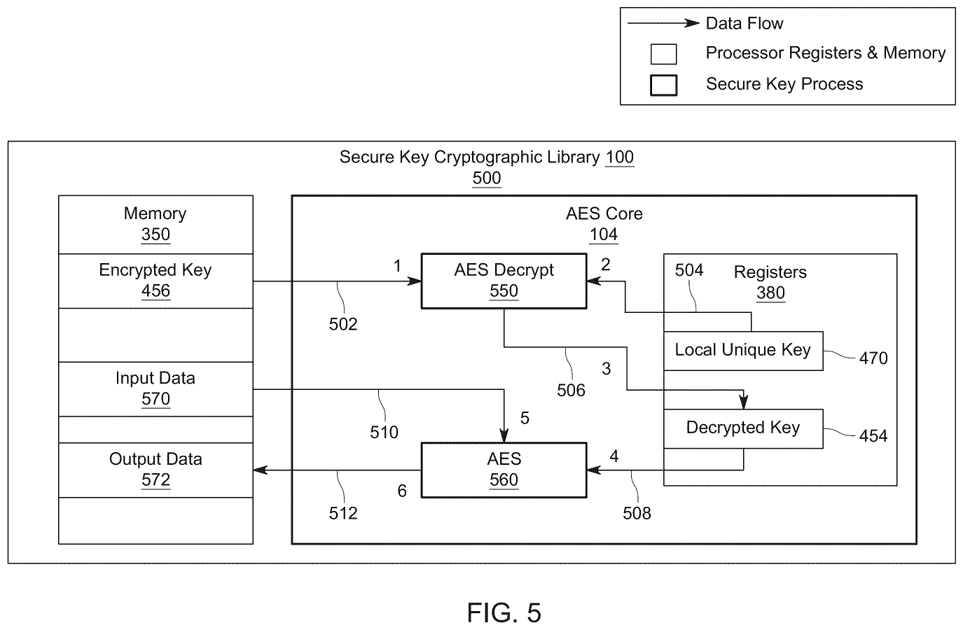

FIG. 5 illustrates a flow diagram of an embodiment to decrypt a symmetric key, according to aspects of the disclosure. While FIG. 5 illustrates examples of components and data processes of the SKCL 100, additional components can be added and existing components and data processes can be removed and/or modified.

The symmetric encryption/decryption process 500 can begin at step 502 where the encrypted ciphertext key 456 can be retrieved from a memory, e.g., the memory 350, and can be loaded into the AES Core 104. At step 504, the LUK 470 can be reconstituted and can be used to perform AES Decryption process 550 on the encrypted ciphertext key 456 to form a plaintext key 454. For example, the masked LUK 362, stored in the registers 380, can be unmasked to access the LUK 470. The plaintext key 454 can be encrypted using an AES GCM algorithm 480.

At step 506, the plaintext key 454 can be temporarily stored into a different set of registers, for example, the registers 380. In embodiments, the plaintext key 454 is never stored to the memory 350. At step 508, the plaintext key 454 can be loaded into an encryption process 560 and, at step 510, input data 570 can be loaded into the encryption process 560. The encryption process 560 uses the key from registers and specifically does not store or use the plaintext key 454 from memory. The plaintext key 454 can be used to encrypt the input data 570 using an AES GCM algorithm. At step 512, output data 572, which is encrypted, can be formed and output to a memory, e.g., the memory 350.

While the symmetric encryption/decryption process 500 is described as encrypting the input data 570, in embodiments, the symmetric encryption/decryption process 500 can be used to decrypt the input data 570 if it was previously encrypted with the plaintext key 454.

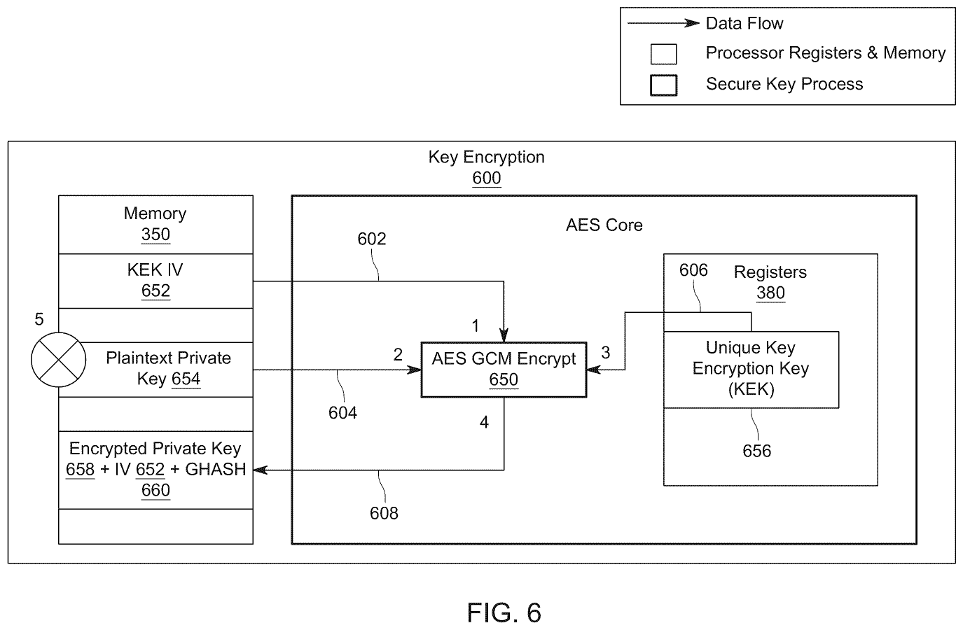

FIG. 6 illustrates a flow diagram of an embodiment to encrypt an asymmetric private key, according to aspects of the disclosure. While FIG. 6 illustrates examples of components and data processes of the SKCL 100, additional components can be added and existing components and data processes can be removed and/or modified.

Key encryption process 600 begins at step 602 where a Key Encryption Key Initialization Vector (KEK IV) 652 can be loaded from a memory, e.g., the memory 350, into the AES Core 104. At step 604, a plaintext private key 654 can also be loaded from a memory, e.g., the memory 350, into the AES Core 104. At step 606, a unique key encryption key (KEK) 656 can be loaded from registers, e.g., the registers 380, into the AES Core 104.

At step 608, the plaintext private key 654 can be encrypted using the KEK IV 652 and the unique KEK 656. The encrypted private key 658 can then be stored to a memory, e.g., the memory 350, with the KEK IV 652 and a GHASH 660. As part of step 608, the plaintext private key 654 can be zeroed to prevent an attack surface. The KEK 656 is a key generated by the SKCL library 100 itself (using random number generator) and can be used for AES-256-GCM encryption of the Asymmetric Private key. The KEK 656 is itself encrypted as described in FIG. 4 (Symmetric Key Encryption). The encrypted private key 658 is written to a memory, e.g., the memory 350, (along with the parameters needed to decrypt it in the future) which includes the KEK IV and a reference to the encrypted KEK.

That is, the LUK is used to encrypt the KEK 656 (which is referenced in FIG. 4), and the KEK 656 is used to encrypt the private Key as shown in 600. When SKCL 100 is used to encrypt a Private Key, first the library generates a random AES key (the KEK) and encrypts that with the LUK (the master key). Then the KEK is used to encrypt the plaintext private key, e.g., LUK→encrypts AES KEK→encrypts Private Key

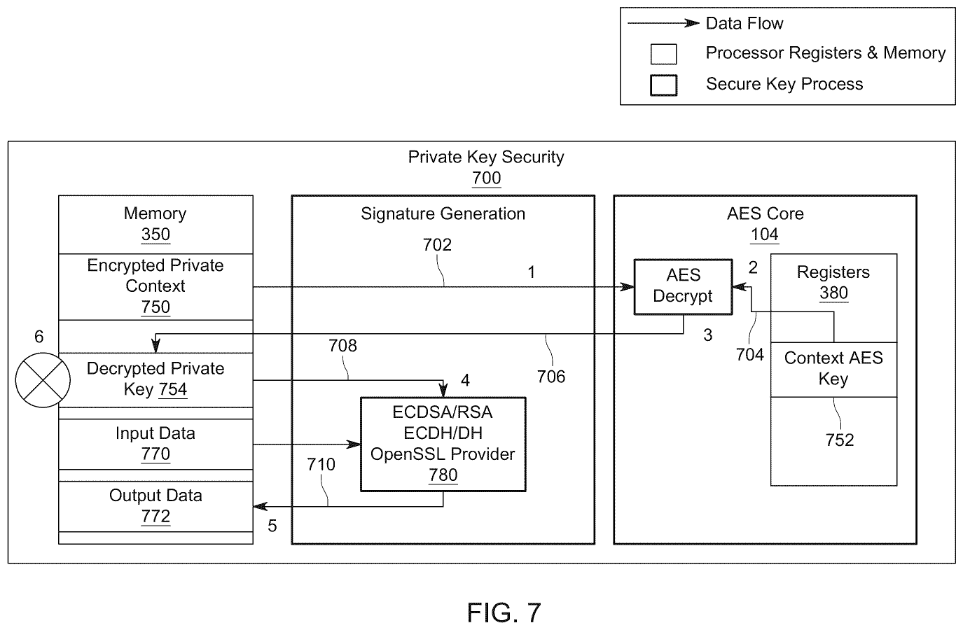

FIG. 7 illustrates a flow diagram of an embodiment to decrypt an asymmetric key, according to aspects of the disclosure. While FIG. 7 illustrates examples of components and data processes of the SKCL 100, additional components can be added and existing components and data processes can be removed and/or modified. Additionally, while FIG. 7 illustrates examples of asymmetric key protection, this method can be used to protect generic data of varying length or any general secret or data that is to be protected in memory. The SKCL 100 can be used to encrypt data using SKCL 100 protected AES keys. The data can be decrypted by SKCL 100, used by the process, and memory can be sanitized after processing has completed.

An unillustrated aspect of the mechanism of FIG. 7 can be that a LUK has been initialized at some time prior to execution of the data flow of FIG. 7. The decryption process 700 begins at step 702 where an encrypted private key 750. The encrypted private key 750 can be stored with an Initialization Vector, GHASH, (as described above with reference to FIG. 6) and encrypted data, can be loaded into the AES Core 104.

At step 704, a context key 752, for example, the KEK described above with reference to FIG. 6, preferably previously decrypted, can be loaded from registers, e.g., the registers 380, into AES Core 104 and can be used to decrypt the encrypted private key 750. In an embodiment, GHASH verification is performed during step 704. As part of AES-GCM decryption a GHASH is generated and this must match the input GHASH (calculated when it was encrypted) to verify the integrity of the decrypted data.

At step 706, the decrypted private key 754 can be stored in a memory, e.g., the memory 350. At step 708, a signature generation process 780 can utilize the decrypted private key to perform key exchange and signature generation with input data 770. In an embodiment, the signature generation process 780 can be OpenSSL. At step 710, the signature generation process 780 can write output data 772 to a memory, e.g., the memory 350. For example, the output data 772 can be a digital signature of the input data 770. ECDSA or RSA may use the private key along with the input data to generate a digital signature (the output data). Likewise, the private key can also be used for other things like key exchange, or in the case of RSA for decryption. Once the process is complete the decrypted private key 754 can be cleared from memory to prevent an attack surface.

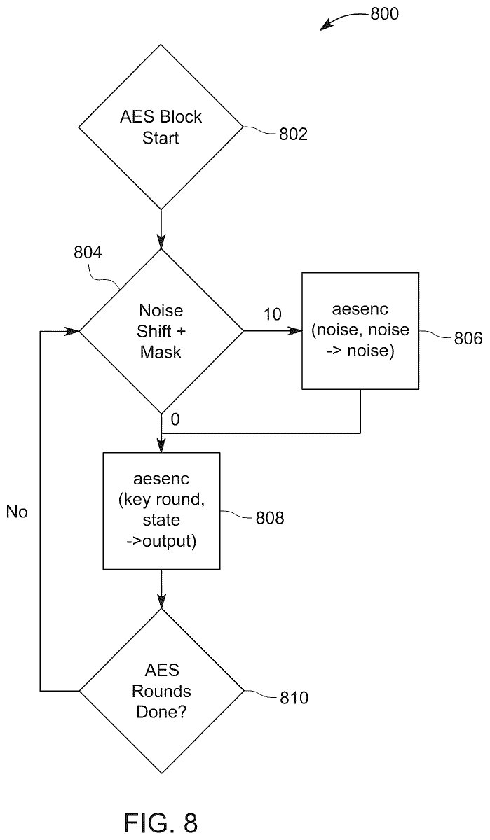

FIG. 8 is an illustration of an embodiment of processor instruction set shielding, according to aspects of the present disclosure. While FIG. 8 illustrates examples of components and data processes of the SKCL 100, additional components can be added and existing components and data processes can be removed and/or modified.

The shielding introduces “dummy” operations, or random noise variances, into normal algorithm flow to provide cover, i.e. mask, true encryption operations. Advantageously, the shielding can mitigate side channel disclosure of data and key material due to timing, power, thermal, acoustic, and electromagnetic radiation analysis. The exemplary shielding method 800 begins at step 802 where encryption block operations can be called from AES Core 104. At step 804, a compression round is started where a register is filled with random bits due to process noise can be shifted and checked against a pre-defined mask. Furthermore at step 804, a result of the check between the random bits register and mask can yield a result, preferably zero or non-zero.

The method 800 proceeds to step 806 if the result of the check is non-zero, where a dummy operation can be introduced using noise for instruction set operations. The method proceeds to step 808 if the result of the check is zero, then no dummy operation can be added. At step 810, it is determined whether the encryption cycle is complete, and if not, the flow returns to 804. In an embodiment, dummy operations can use the noise register as input for a single operation, where the output is also stored to the noise register, effectively stirring the random register each time it is used.

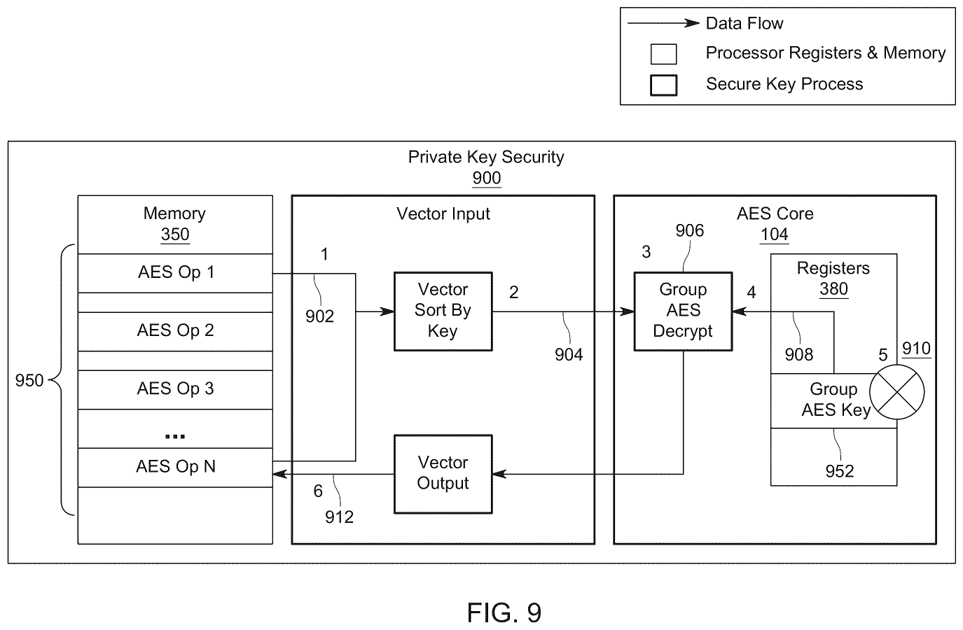

FIG. 9 is an illustration of an embodiment of vector packet processing, according to aspects of the present disclosure. While FIG. 9 illustrates examples of components and data processes of the SKCL 100, additional components can be added and existing components and data processes can be removed and/or modified.

Vectorization has been shown to improve performance in applications making optimal use of modern processor architectures and caching mechanisms. Vector processing process 900 begins at step 902 where encryption operations 950, e.g., AES op 1, AES Op 2 . . . . AES Op N, stored in a memory, e.g., the memory 350 can be combined into an array of encryption operations by an application and provided to a vector sorting mechanism. The vector sorting mechanism can take the array and sort the operations into groups that use the same key.

At step 904, each grouping of operations 950 that use the same key can be sent to the AES core 104, serially, on the same cryptographic thread for performing decryption operations. At step 906, a group operation key 952 can be decrypted using the LUK and temporarily held in the AES core 104 registers, e.g., the registers 380. Furthermore, the decrypted key can be cached in registers, e.g., the registers 380, while processing the entire group of packets that use it. Advantageously, this can improve performance as normal operations require a full key decryption process to occur before the requested operation is performed.

At step 910, the decrypted key can be zeroed from registers, e.g., the registers 380, after the last operation using that key is completed to prevent an attack surface. At step 912, all operations can be completed for the entire vector input and the output can be available to the calling thread which can be waiting for the result.

The novel system and methods include additional functions to support, monitoring, verification, and validation, and are further described below. The mechanism to isolate memory for use by the SKCL 100 is described. Following initialization, the library can allocate a pool of memory that can be private to the SKCL 100 and can be accessible by internal library methods. Next, caller operations can be received, and memory can be allocated from the private memory pool and caller input data can be copied to the private memory buffer. Output buffers can then be reserved from a different memory pool. All library cryptographic operations can be performed using the private memory input and output buffers, protecting against buffer overflow and memory corruption that may result from caller managed memory. Library private output data can be copied to the caller output buffer following successful processing and ensuring only finalized data is returned. After the memory isolated operation has completed, all library private memory can be sanitized and returned to the private memory pool.

A mechanism to isolate and protect the SKCL 100 memory used to store security parameter data is described. Following the SKCL 100 initialization, the SKCL 100 can allocate private memory used to store security parameters which can include encrypted keys. When the SKCL 100 stores a security parameter to memory it can allocate memory from the private key pool and return an opaque reference to the caller. The opaque data structure can have limited information about the security parameter and can include an index, cryptographic hash, and usage information. Caller operations can reference the security parameter using the opaque pointer, and the library can validate the cryptographic hash and usage permissions before using the security parameter. These checks can be used to verify that the caller has permissions to use the security parameter and that the data has not been modified to prevent an attack surface. When requested or upon library termination, the SKCL 100 can securely zeroize the memory used to hold security parameters that have been created throughout the lifetime of the library.

A mechanism to generate non-deterministic random bits using both hardware and software-based entropy is described below. Once the SKCL 100 has been initialized, a processor instruction can be used to generate 64 random bits at a time which can be stored in a buffer until the requested number of bytes is reached. In an embodiment, the processor instruction can come from the x86 line of instructions, and can be an RDRAND instruction. A software library for generating process noise can then be used to generate random bits in a buffer until the requested number of bytes is reached. In an embodiment, the SKCL 100 is the jitterentropy library. Finally, the outputs from the processor instruction and software library can be combined, using a logical operation, into the request output buffer. In an embodiment the logical operation is an exclusive-OR (XOR). After the process is complete the random bit buffer are zeroed to prevent an attack surface.

In one example, a mechanism to provide Trusted Execution Environment integration and protections for the SKCL 100 is described. The SKCL 100 can use certificate-based signature verification to verify platform integrity and security settings. In an embodiment, AMD Secure Encrypted Virtualization (SEV) Secure Nested Paging (SNP) can be used. Once the SKCL 100 has been initialized, but before cryptographic operations can be performed and when enabled by configuration settings, the library can perform processor security verification on supported platforms. The SKCL 100 can request a system attestation report to be generated by a secure processor. An operating system kernel can perform operations involving a Host Hypervisor (e.g., KVM) and system security processor platform to generate the attestation report. The SKCL 100 can read data results from the operating system kernel and can perform signature verifications. A certificate chain including certificate authority (CA) and Root CA can be built into the library executable, a Versioned Chip Endorsement Key (VCEK) can be provided in a file format at runtime using environment variables to supply the filename. Finally, If the system attestation report passes verification, then the SKCL 100 can be allowed to perform operational Cryptographic operations. In an embodiment, the process can be repeated during runtime periodically as part of the continuous Monitoring thread.

In one example, a mechanism to provide novel memory integrity verifications is described. Memory integrity checks can be performed as part of Power On Self-Test (POST) and continually during runtime within the monitor thread. Memory integrity checks can include a SHA-384 hash over all of the executable memory in RAM that can be part of the core cryptographic code, and also an ECDSA-384 signature check over the hash. In this way memory corruption can be detected using cryptographically strong algorithms. Prior to integrity verification, compile time measurements of the SKCL 100 can be taken and a SHA-384 hash+ECDSA-384 signature can be generated. A Public key for the Integrity signature can be stored in the executable image and/or provided at runtime. Once a library constructor is called, Power On Self-Test initiates memory integrity verifications. The SKCL 100 can call commands to locate the memory address used to hold the executable memory. The SKCL 100 can read the memory from RAM and can generate a SHA-384 hash using OpenSSL functions. The SHA-384 hash can be verified to match the one that was calculated at compile time. The SHA-384 hash value can be used as input to an ECDSA-384 signature verification OpenSSL function along with the hardcoded image signing Public Key. Both the Hash and the signature verification must pass to continue power on self-test. These steps are repeated continuously as part of the monitor thread processing.

In one example, a mechanism used to monitor system health and verify algorithm correctness by performing self-tests and algorithm known answer tests (KAT) is described. The monitor thread can run continuously and can perform KATs and self-tests on a periodic basis. Any failure can result in termination of the crypto library process. Once a SKCL 100 is initialized, a Monitor Thread can wake and perform an incremental self-test. First, a memory integrity check can be performed, described above. Next, Known Answer Tests can be performed to validate algorithm correctness. Known Answer Test operations can be input into the crypto thread queues as all normal input is and no indication is made that these are for the purpose of self-tests. An output can be verified to pass the self-test, statistics can be gathered and updated, and monitor thread can sleep for a set amount of time. Finally, monitor thread can run periodically until the SKCL 100 is terminated.

A mechanism to provide novel software fail safety and fatal signal handling is described. Once a SKCL 100 is called, signal handlers can be installed for all fatal signals on each thread that the library creates. Non-fatal signals can be masked in all threads except the signal handling thread. The signal handling thread can be created to listen for all signals. When a signal is delivered to the process the signal thread can wake up and can process the signal. Fatal signals can indicate a failure condition has been encountered and the SKCL 100 can be securely terminated as follows: secure termination of threads can be performed by installing a thread cancellation handler at thread startup which can unconditionally sanitize the registers used to hold security parameters upon thread termination; when a thread is terminated the cleanup function can be called and a thread local counter can be incremented to indicate sanitization has completed on the thread; the signal handler thread can wait for all other threads to terminate and sanitize fully before exiting; and finally, proof of sanitization can be saved in a file. After exit, the SKCL 100 threads can be terminated and all protected key material can be rendered safe since the LUK and other security parameters are cleared.

It should be understood, of course, that the foregoing relates to exemplary embodiments of the disclosure and that modifications may be made without departing from the spirit and scope of the disclosure as set forth in the following claims.

What is claimed is:

1. A method for operating secure computer processes, comprising:
storing a local encryption key in one or more registers of a processor, wherein the local encryption key is stored in a masked state;
receiving, from a memory of a computing device communicating with the processor, an operational encryption key;
encrypting the operational encryption key using the local encryption key and an initialization vector to generate an encrypted operational key, wherein the local encryption key is unmasked prior to encrypting the operational encryption key;
storing the encrypted operational key, the initialization vector, and a verification hash value in the memory; and
removing the operational encryption key from the memory.

2. The method of claim 1, further comprising:
receiving, from the memory, input data to be encrypted and the encrypted operational key;
decrypting the encrypted operational key to recover the operational encryption key;
storing the operational encryption key in the one or more registers of the processor, and
encrypting the input data using the operational encryption key.

3. The method of claim 2, wherein the operational encryption key is a symmetric key and the operational encryption key is never stored in the memory of the computing device.

4. The method of claim 2, further comprising:
decrypting a private key of an asymmetric key pair using the operational encryption key, wherein the private key is temporarily stored in the memory of the computing device, and the memory of the computing device is sanitized after the use of the private key.

5. The method of claim 4, further comprising:
generating one or more digital signatures using the private key.

6. The method of claim 1, further comprising:
generating a random number seed; and
performing a logical combination function on the random number seed and a mask to generate the local encryption key in a masked state.

7. A method for operating secure computer processes, comprising:
receiving, from a memory of a computing device communicating with a processor, an operational encryption key that is encrypted;
decrypting the operational encryption key using a local encryption key stored in one or more registers of the processor;
maintaining the operational encryption key, which was decrypted, in the one or more registers of the processor, wherein the operational encryption key is never stored in the memory of the computing device;
receiving input data to be encrypted or decrypted using the operational encryption key; and
encrypting or decrypting the input data using the operational encryption key of one or more registers of the processor.

8. The method of claim 7, wherein the input data is a private key of an asymmetric key pair.

9. The method of claim 7, wherein the local encryption key is masked when stored in the one or more registers of the processor.

10. A computer system for encrypting data, comprising:
a memory; and
a processor coupled to the memory and comprising one or more registers, wherein the processor is configured to execute instructions to perform a method comprising:
receiving, from the memory, an operational encryption key that is encrypted,
decrypting the operational encryption key using a local encryption key stored in the one or more registers,
maintaining the operational encryption key, which was decrypted, in the one or more registers of the processor, wherein the operational encryption key is never stored in the memory,
receiving input data to be encrypted or decrypted using the operational encryption key, and
encrypting or decrypting the input data using the operational encryption key of the one or more registers.

11. A computer readable medium storing instructions for causing a processor to perform a method, the method comprising:
receiving, from a memory of a computing device communicating with the processor, an operational encryption key that is encrypted;
decrypting the operational encryption key using a local encryption key stored in one or more registers of the processor;
maintaining the operational encryption key, which was decrypted, in the one or more registers of the processor, wherein the operational encryption key is never stored in the memory of the computing device;
receiving input data to be encrypted or decrypted using the operational encryption key; and
encrypting or decrypting the input data using the operational encryption key of one or more registers of the processor.
